(19) United States
(12) Patent Application Publication
(10) Pub. No.: US 2001/0052840 A1
(43) Pub. Date: Dec. 20, 2001

(54) Paging device

(76) Inventors: Ranjan Ghosh, Bangalore City (IN); Gopalakrishna Ramakrishna Holla, Bangalore (IN)

Correspondence Address: Docket Administrator (Room 3J-219), Lucent Technologies Inc., 101 Crawfords Corner Road, P.O. Box 3030, Holmdel, NJ, 07733-3030, US

(21) Appl. No.: 09/881,372

(22) Filed: Jun. 14, 2001

(30) Foreign Application Priority Data
Jun. 20, 2000 (EP) 00305204.0

(51) Int. Cl. G08B 5/22

(52) U.S. Cl. 340/7.43; 340/7.63

(57) ABSTRACT

A pageable electronic badge including a laminate display of electronic ink energized by plastic transistors wearable by a user such that the user can be paged within a wireless LAN conforming to wireless LAN standard IEEE 802.11.

### CROSS-REFERENCE TO RELATED APPLICATION

This application claims priority of European Patent Application No. 00305204.0, which was filed on Jun. 20, 2000.

### BACKGROUND OF THE INVENTION

1. Field of the Invention

The present invention relates to a paging device, and more particularly to an electronic identification badge which can function as a pager so as to minimize the inconveniences caused to a wearer due to size considerations of the device.

2. Description of the Related Art

Paging devices are known and are commonly used by people who need to be contactable when away from their usual place of work. Messages sent to a user are transmitted over a wireless network and are received by a paging device carried by the user. These devices are typically palm-sized and are compact enough to fit into a trouser or coat pocket, etc. The user is usually alerted to the presence of an incoming message by either an audible alert signal or through vibration of the device itself.

Many people have objections to carrying or wearing (on a belt for instance) a paging device because of the inconvenience caused by the size and shape of many commonly available devices.

Microprocessor-based technology has facilitated a reduction in size of many electronic devices, and the ability to hold vast amounts of information on everyday items such as credit cards, identification cards and the like.

Many of the devices mentioned above may incorporate an LCD display screen. Such screens require a considerable proportion of the actual size of the device given the number and type of components required for the functioning of the display, and they are power hungry thus giving rise to energy storage problems in an already overcrowded device. A recent joint development by E-Ink Corporation and Bell Labs, Inc. has produced a thin, lightweight alternative to a conventional LCD display. Bell Labs have developed a silk screen technique for printing plastics transistors on flexible transparent film. Independently E-Ink Corporation have developed an electronic ink that is printable onto almost any surface. The ink comprises millions of tiny micro-capsules, each micro-capsule contains a white particulate suspended in a sepia-like dye. The white particles are positively charged and are therefore responsive to an applied electric field; a micro-capsule is made to appear white or dark depending on the polarity of the electric field.

Bell Labs and E-Ink have produced a plastic laminate circuit onto which electronic ink is printed. The circuitry forms an energizing grid controllable from an electronic display driver.

### SUMMARY OF THE INVENTION

According to an aspect of the present invention there is provided a paging device including an electronic token and a token holder attachable to a user; the electronic token comprising a data interface connectable to the token holder, a memory, a processor, and a display; the token holder comprising a display controller and a paging receiver; wherein the data interface connects with the display controller and the paging receiver upon engagement of the electronic token with the token holder.

According to another aspect of the present invention there is provided an electronic badge wirelessly communicable with a LAN access point transceiver and including an electronic ink display for displaying received paging messages transmitted from the LAN access point transceiver.

According to a further aspect of the present invention there is provided an electronic pager comprising an electronic ink display.

The invention further provides an identify badge comprising means for receiving and displaying messages from a remote source.

### BRIEF DESCRIPTION OF THE DRAWINGS

FIG. 1 is a schematic diagram of an embodiment of a paging device of the present invention;

FIG. 2 is a schematic diagram of an electronic token of the paging device of FIG. 1;

FIG. 3 is a schematic diagram of a token holder of the paging device of FIG. 1;

FIG. 4 is a schematic diagram of the paging device of FIG. 1 in use within a local area network; and

FIG. 5 is a sectional view of an electronic ink display.

### DESCRIPTION OF PREFERRED EMBODIMENTS

An embodiment of the invention will be described with reference to the accompanying drawings.

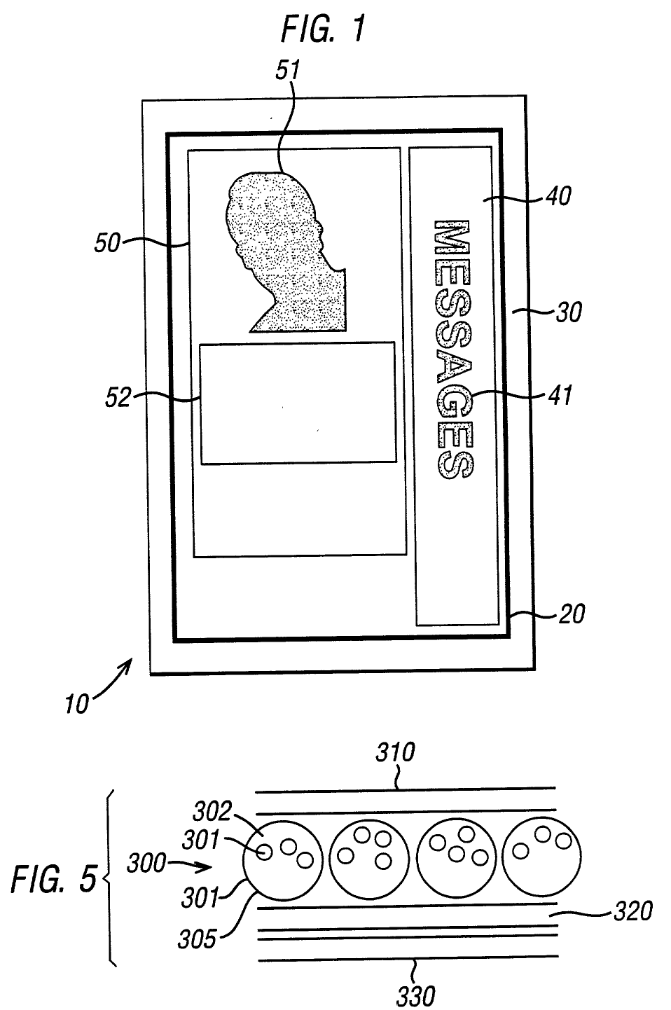

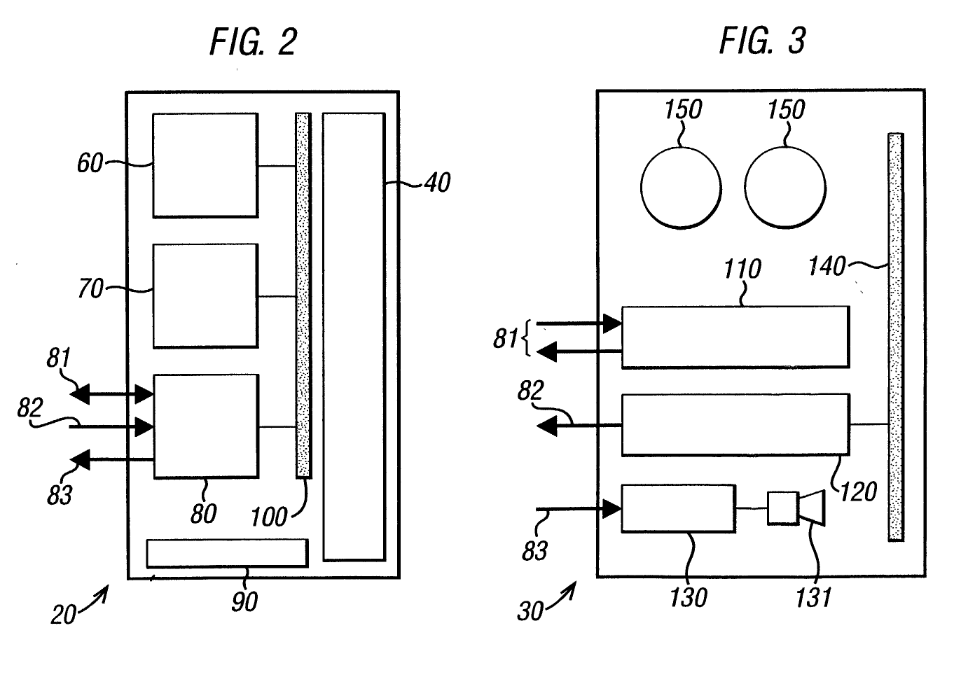

FIG. 1 shows an embodiment of a paging device 10 comprising an electronic token, typically a microprocessor-based electronic laminate 20 (see also FIG. 2) or the like, and a token holder 30. The token holder (see also FIG. 3) provides a platform on which the electronic token 20 is mounted, and can preferably be securely attached to a user by an appropriate means. Such means may include a clip, clasp or sliding mechanism, or a pin-type fastener. The holder also may be hung around the neck of a wearer in a similar manner to a pendant.

The outward-facing surface of the electronic token 20 is sub-divided into two main sections: a display section 40 and a user identification section 50. The display section 40 includes an area of electronic ink interposed between an upper transparent electrode and a lower electrode, which in combination are laminated to a plastic transistor circuit that controllably energizes the area of electronic ink above the circuit.

A schematic sectional view of a portion of the display section 40 is shown in FIG. 5. Electronic ink 300 which has been developed by E-Ink Corporation, Cambridge, Massachusetts, USA, is interposed between a first electrode 310 which is transparent, and a second electrode 320. The ink comprises micro-capsules 301 which are formed from a clear outer shell 305 enclosing a dark dye 302. Suspended within the dye is a white particulate 303. Lying beneath the lower second electrode 320 is a lamina of plastic transistors comprising the display energizing circuit. The plastic transistors, which can be printed onto a flexible plastic sheet, have been developed by Lucent Technologies Bell Laboratories, Murray Hill, N.J., USA.

The particles of the particulate 303 are positively charged, thus a negative potential applied to electrode 310 will cause the particles to drift towards and accumulate in the upper region of the micro-capsule. When viewed from above through the transparent electrode 310, the region of the display corresponding to this micro-capsule (pixel) will appear white. Conversely, applying a positive potential (relative to electrode 320) will render the same region dark. With a circuit of plastic transistors 330 lying beneath the electrode 320, specific regions of the ink display can be selectively turned white or dark by controlling the applied potential to corresponding regions of the electrode layers by selectively energizing respective ones of the transistors within the circuit 330.

The user identification section 50 of the display section 40 (see FIG. 1) is provided for the inclusion of an identity photograph 51 and identification details area 52. Section 50 may, in some embodiments, be an adhesive film onto which relevant details and images are printed, but which can be peeled off and removed to allow for reuse of the electronic token 20. Identification details area 52 may contain such details as name, employee number and an identification bar-code or the like.

FIG. 2 is a sectional view showing the interior of the electronic token of FIG. 1. Included within the token is display circuitry (designated generally as 40 for simplicity), a processor 60, a memory 70 and a data interface 80. Also provided is a power supply 90 which distributes and regulates current flow from battery cells 150 (see FIG. 3). Control signals for the selective energizing of the plastic transistors within display circuitry 40 are disseminated via display control line 100. The processor 60 will preferably include a standard microprocessor as appropriate to the functionality of the device. The memory 70 is preferably as electrically erasable programmable read only memory device (EEPROlv17 for storing the specification parameters and protocols of the wireless local area network (LAIC standard IEEE 802.11. A link for connecting to the laminate holder (or for receiving external data) is represented by data interface section 80. This interface provides data links 81, 82 and 83 which represent interconnect lines between display driver section 110, IEEE 802.11 physical section 120, and alert signal unit 130 respectively. In some embodiments, these components can be integrated in the form of an ASIC.

The token holder 30 of FIG. 3 shows a display driver section 110, IEEE 802.11 physical section 120 and an alert signal unit 130 connected to signal transducer 131. IEEE 802.11 physical section 120 is connected to as antenna strip 140 running down a peripheral edge of the holder. Also shown are replaceable battery cells 150; these will typically be small disc shaped lithium batteries as are commonly used in calculators and cameras.

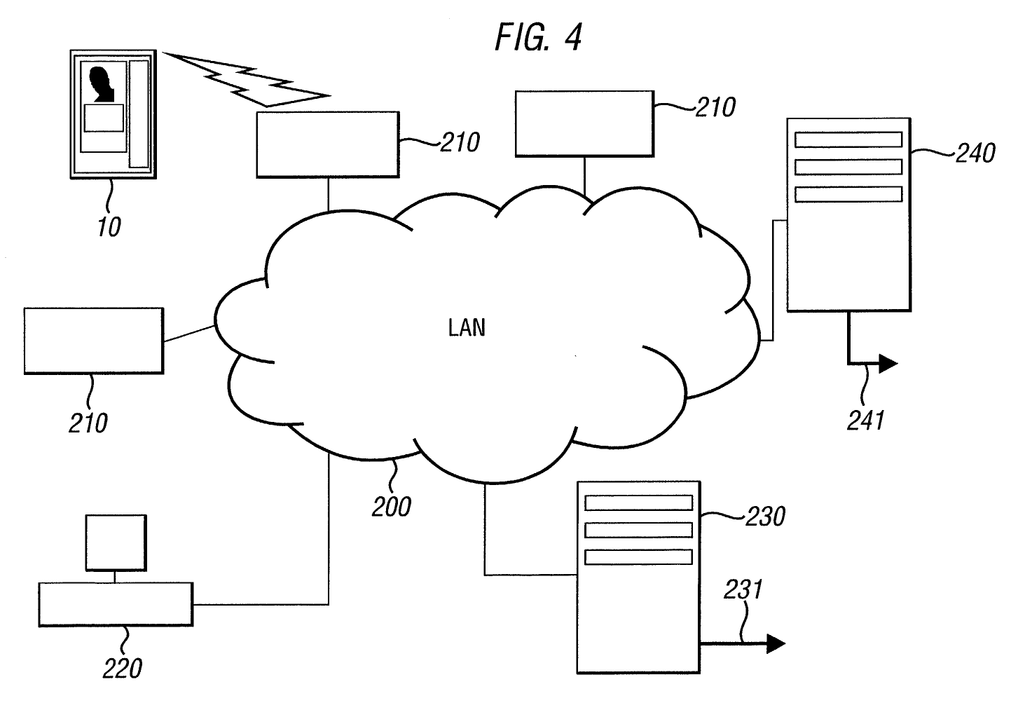

In use, the electronic token 20 is secured to the token holder 30 which is affixed, in turn, to a suitable item of apparel of a user in the same way one might attach a name badge or an identity card. Token 20 and holder 30 constitute the paging device 10 operable within a local area network (LAN) as depicted in FIG. 4.

Referring to FIG. 4, a LAN, designated 200, comprises amongst others, a computer terminal 220, several wireless LAN access point transceivers 210 (which will be IEEE 802.11 compatible), a LAN server 230 and an Internet server 240. A user adorned with the paging device 10 is pageable via a local access point transceiver. A sender wishing to send a message to the paging device 10 will access paging software stored on the LAN server 230 from the terminal 220. After successfully providing security passwords and an identifier (this may be in the form of an e-mail address, telephone extension number, pager number, etc) of the remote device 10, a sender types in the required message and confirms its transmission. The message is then sent to the server 230 which translates the identification number submitted by the sender to the medium access control (MAC) address dictated by the IEEE 802.11 standard. From the server 230, the message is disseminated to all local access point transceivers 210; alternatively software may be provided within server 230 which will locate the local access point transceiver which is in closest proximity to the device 10. The transceivers transmit a radio signal, typically in the range 2.4 GHz to 2.4835 GHz which is picked up by the antenna strip 140 buried within the paging device 10. Optionally, the device 10 will emit back an acknowledgement signal to the server 230. Alternatively, other types of signal such as infrared or microwave may be used.

Inside the paging device 10, the message signal is fed through IEEE 802.11 physical section 120 and directed via data interconnect line 82 to the data interface 80. Within the electronic token 20 the signal is translated and processed by the processor section 60 which in turn determines the required control signals to be sent from the display driver section 110 to the display 40 where the sender's message is displayed. The wearer of paging device 10 is made aware of an incoming message by an alert sound emitted from transducer 131 which is controlled by the alert signal unit 130 that receives input signals from the data interface 80.

In other embodiments of the paging device 10 the display 40 may comprise a lightweight LCD display or other such screen. Also, the entire outward surface of the electronic token may be coated with electronic ink, or be otherwise configured as a variable display (e.g. LCD display, etc.) thus enabling identification photographs and identification details to be input electronically through the data interface section. In other embodiments, the electronic laminate is envisaged as being programmable.

FIG. 4 also shows an Internet server 240 including an Internet link 241. The Internet server 240 provides access to a dedicated paging network web page. This web page can be accessed by any person who has authorization to access the LAN 200. Thus, from a remote terminal (not shown) a sender can access the paging network web page via the Internet, and send a message to a paging device 10 located within the LAN 200. Also, if a user 10 moves outside the LAN 200 into an external telephone or paging network, the paging device 10 may be pre-configured to receive messages on an external communications network. For example, a sender sends a message from the terminal 220 and the server 230 determines that the device is not located within the LAN 200. The server software will then elect to dial-up an external telephone network through an external communications links 231 and transmit the message to the paging device I O in a manner known from conventional paging systems.

What is claimed is:

1. A paging device including an electronic token and a token holder adapted to be attachable to a user and adapted to engageably receive the electronic token; the electronic token comprising a data interface connectable to the laminate holder, a memory, a processor, and a display; the token holder comprising a display controller and a paging receiver; wherein the data interface connects with the display controller and the paging receiver upon engagement of the electronic token with the token holder.

2. The paging device of claim 1, wherein the electronic token is an electronic laminate.

3. The paging device of claim 1, wherein the electronic token is a microprocessor-based intelligent device.

4. The paging device of claim 1, wherein the display comprises an electronic ink display.

5. The paging device of claim 3, wherein the display is a laminate of a first lamina electrode; electronic ink; a second lamina electrode; and a sheet of plastic circuitry.

6. The paging device of claim 5, wherein the first lamina electrode is transparent and the plastic circuitry comprises plastic transistors.

7. The paging device of claim 5, wherein the display section covers an entire outward surface of the electronic laminate.

8. The paging device of claim 2, wherein the display section is an LCD display.

9. The paging device of claim 1, wherein the paging device is programmable.

10. An electronic badge wirelessly communicable with a LAN access point transceiver and including as electronic ink display for displaying received paging messages transmitted from the LAN access point transceiver.

11. The electronic badge of claim 10, wherein the display comprises a laminate of a first laminate electrode which is transparent; a second laminate electrode; electronic ink interposed between the first and second laminate electrodes; and a sheet of plastic circuitry located beneath the second laminate electrode.

12. The electronic badge of claim 11, wherein the sheet of plastic circuitry includes plastic transistors.

13. The electronic badge of claim 12, wherein an entire outward surface of the badge is a display.

14. The electronic badge of claim 12, wherein the electronic laminate badge includes programmable means.

15. The electronic badge of claim 12, wherein the electronic laminate badge conforms to wireless LAN standard IEEE 802.11.

16. The electronic badge of claim 10 comprising means of locating itself.
